(19) United States
(12) Patent Application Publication
(10) Pub. No.: US 2012/0019238 A1
(43) Pub. Date: Jan. 26, 2012

(54) MAGNETIC INDUCTION TOMOGRAPHY SYSTEMS WITH COIL CONFIGURATION

(75) Inventors: Roland Eichardt, Nerkewitz (DE); Alistair Lee Mcewan, Edgecliff NSW (AU)

(73) Assignee: KONINKLIJKE PHILIPS ELECTRONICS N.V., EINDHOVEN (NL)

(21) Appl. No.: 13/258,633

(22) PCT Filed: Mar. 23, 2010
(86) PCT No.: PCT/IB10/51251

§ 371 Date: Sep. 22, 2011

(30) Foreign Application Priority Data
Mar. 30, 2009 (EP) 09156653.9

(51) Int. Cl. G01N 27/72

(52) U.S. Cl. 324/239

(57) ABSTRACT

A magnetic impedance tomography system comprises an excitation system with several excitation coils to generate an excitation magnetic field to induce eddy currents in an examination volume. For example, a solenoid configuration or parallel coils, e.g. in a Helmholtz configuration are employed, Further, a measurement system is provided with several measurement coils to measure the fields generated by the induced eddy currents. The measurement coils are arranged in a volumetric (3D) geometrical arrangement. The individual measurement coils being orientated substantially transverse to the field line of the excitation magnetic field of the excitation coils. A reconstructor receives measurement data from the measurement system and reconstruct an age of an object in the volume of interest from the measurement data.

### FIELD OF THE INVENTION

The invention pertains to a magnetic impedance tomography (MIT) system with an excitation coil system and a measurement coil system. The excitation coils and the measurement coils are placed around a volume of interest (VOI). In general, when the excitation coils are activated, eddy currents are generated in a conductive object within the

VOI. By way of the measurements coils, the magnetic field generated by these eddy currents is measured. From the acquired measurement data, conductivity properties of the object (e.g. in the form of images) can be reconstructed.

### BACKGROUND OF THE INVENTION

Such a magnetic impedance tomography system is mentioned in the US-patent application U.S. 2008/0246472 as a system for inductively measuring bio-impedance of conductive tissue.

In the known magnetic impedance tomography system a generator coil is provided to generate a primary magnetic field that passes through conducting material (e.g. tissue). This flux induces eddy currents in the tissue. A single sensor coil measures the secondary magnetic field that is generated by the induced eddy currents. The generator coil and the sensor coil are perpendicularly orientated. In this way there is no net flux from the generator coil through the sensor coil. The known magnetic impedance tomography system includes an additional shimming coil to cancel the primary magnetic field in the sensor coil. As a result the sensor coil senses only the secondary magnetic field.

### SUMMARY OF THE INVENTION

An object of the present invention is to provide a magnetic impedance tomography system which has an improved image quality, notably for volumetric objects.

This object is achieved by the magnetic impedance tomography system of the invention comprising
an excitation system with several excitation coils to generate an excitation magnetic field to induce eddy currents in an examination volume,
a measurement system with several measurement coils to measure the fields generated by the induced eddy currents,
the measurement coils being arranged in a volumetric (3D) geometrical arrangement and
the individual measurement coils being orientated substantially transverse to the field line of the excitation magnetic field of the excitation coils and
a reconstructor to receive measurement data from the measurement system and reconstruct an image of an object in the volume of interest from the measurement data.

The measurement coils are arranged in a 3D volumetric arrangement so that the measurement coils surround or partly enclose a volumetric examination region. Thus, a volumetric object, such as the head of a patient to be examined can be placed in the volumetric region and eddy currents induced in the object can be measured. Measurements for the respective measurement coils can be performed simultaneously, i.e. in parallel, so that only a short measurement time of a few seconds or less is required to obtain the data from the volumetric object inside the VOI. Alternatively, the excitation coils can be driven sequentially in that sets (e.g. pairs) of coils at different, e.g. opposite, locations around the examination volume are activated. When a larger number of measurements is performed that contain independent information, then the quality of the reconstructed image is improved, due to the higher content of total measurement information, and as consequence also because of the lower noise and artifacts levels.

Also the excitation coils are positioned so as to surround the examination volume. The individual measurement coils are orientated substantially transverse to the field lines of the magnetic field generated by the excitation coils. For example when the excitation coils generate a homogeneous magnetic field in which the field lines run parallel, then the measurement coils are orientated transverse to the excitation coils. Thus, the measurement coils hardly or not at all pick up the flux of the excitation magnetic field generated by the excitation coils. Meanwhile, a homogenous excitation magnetic field is generated by the excitation coils in the examination volume. Consequently, the dynamic range of the signals received by the measurement coils is significantly reduced as compared to signals induced by the excitation magnetic field, and the sensitivity to the induced magnetic field caused by the eddy currents is increased. Also, the small dynamic range allows the use of ultra low noise fixed gain amplifiers in the measurement system.

The measurement data form the measurement coils are applied to a reconstructor which reconstructs an image, notably a volumetric image of the object in the examination volume.

These and other aspects of the invention will be further elaborated with reference to the embodiments defined in the dependent Claims.

There are various ways to configure the excitation coils and the measurement coils such that the measurement coils are orientated transverse to the excitation magnetic field. A simple arrangement is to provide a pair of excitation coils orientated in parallel. A standard Helmholtz configuration achieves good results for the excitation coils. Only a single power source is required for the Helmholtz coil pair. A solenoid coil has a very good homogeneity of the excitation magnetic field and also requires only a single power source. Further, multiple Helmholtz pairs can be operated in parallel which may be coupled to a single power source or for respective pairs of coils in individual power source can be provided. In each of these configurations the measurement coils can be orientated transverse to the excitation coils.

In an example of the invention, the excitation coils are arranged in a Helmholtz-like configuration to excite a homogeneous magnetic field. The homogeneous field extends in the region between the coils of an individual Helmholtz pair. A Helmholtz pair has two identical round magnetic coils placed symmetrically one on each side of the examination volume along a common axis, and separated by a distance h, whereas for classical Helmholtz coils h is equal to the radius R of the coil. In operation each coil carries an equal electrical current flowing in the same direction. Setting h=R, which is what defines a Helmholtz pair, minimizes the non-uniformity of the field (B) at the centre of the coils.

In another example the excitation coils are formed as a solenoid which generates a magnetic field that is homogeneous in the centre region of the solenoid. The centre region of homogeneous magnetic field is larger (along the longitudinal axis of the solenoid) as the solenoid is longer.

In one aspect of the invention, the magnetic impedance tomography system has the measurements coils arranged in a hemispherical geometrical arrangement. That is, the centres of the measurement coils are located on a hemispherical surface while the area of the coil loop is orientated transversely to the field lines of the magnetic field generated by the excitation coils. In this arrangement the measurement coils are located close, i.e. at a short distance, to the volumetric object. The distance to the object should be as close as possible to provide high sensitivities, and it is only limited by practical constraints like suitability for different volumes or manufacturing reasons. Distances between 1 and 4 cm are feasible for objects like the human head. Additionally, the sensitivity of the measurement system is spatially more homogeneous compared to MIT systems with excitation and measurement coils in one layer.

In a further aspect of the invention, excitation coils at opposite ends of the examination volume are electrically connected. Thus, these excitation coils are simultaneously activated to produce a homogeneous magnetic field in the examination volume.

In a further aspect of the invention the excitation coils are arranged at the surface of a metallic or non-metallic cylinder and transversely to the longitudinal axis of the cylinder. A metallic cylinder provides very good shielding from electromagnetic disturbances from the outside. Also a simple non-metallic, such as plastic cylinder carrier can be used. Thus a homogenous magnetic field is generated in the examination volume. The excitation coils can be activated simultaneously or sequentially in combination of respective parts of the examination coils. For example, the excitation coils can be activated in sequential Helmholtz pairs.

In another aspect of the invention, the measurement coils are slightly tilted. In this way slight inhomogeneities of the excitation magnetic field can be compensated for. The magnetic impedance tomography system of the invention for example has magnetic field sensors, e.g. in the form of reference coils to measure the local magnetic field. On the basis of the measured local field orientation the measurement coils can be tilted so as to orientate accurately perpendicularly the local direction of the excitation magnetic field.

In a further aspect of the invention, the measurement coils are positioned on a non-metallic carrier, such as a plastic rack. The individual measurement coils on the non-metallic carrier are positioned transversely to the individual excitation coils on the cylinder.

These and other aspects of the invention will be elucidated with reference to the embodiments described hereinafter and with reference to the accompanying drawing wherein

### BRIEF DESCRIPTION OF THE DRAWINGS

FIG. 1 shows a schematic representation of a magnetic impedance tomography system of the invention and

FIG. 2 shows a schematic representation of a Helmholtz configuration on two coils.

### DETAILED DESCRIPTION

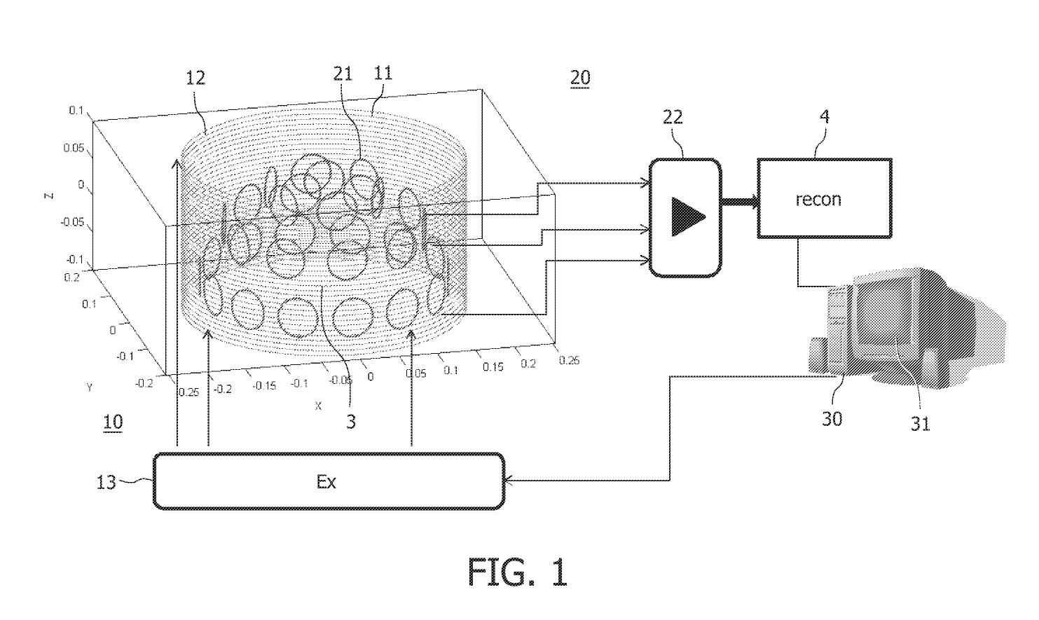

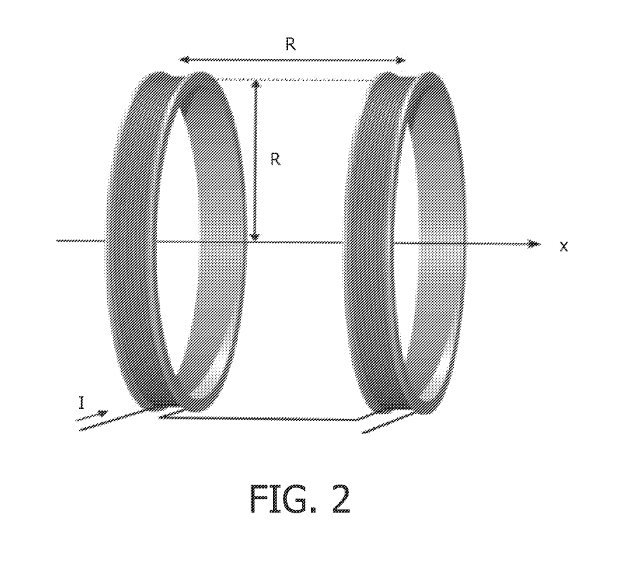

FIG. 1 shows a schematic representation of a magnetic impedance tomography system of the invention. The excitation system 10 includes the excitation coils 11 and an excitation circuit 13. The excitation coils 11 are arranged on the cylindrical surface of a cylinder 12, An excitation circuit 13 is provided to activate selected excitation coils. The excitation circuit 13 includes current supplies for the excitation coils. For example the excitation circuit applies electrical current to pairs of excitation coils 11 that are in a Helmholtz configuration (see FIG. 2). The excitation circuit 13 is controlled by a system computer 30. The system computer can be a suitable programmed general purpose computer. Alternatively, the system computer is a specially configured processor.

The measurement system 20 comprises the measurement coils 21 and a measurement circuit 22. The measurement coils 21 have their centres located on a hemispherical surface. Thus, the measurement coils 21 are located around the examination volume 3. Further, the area enclosed by the respective coil loops of the measurement coils 21 are oriented perpendicularly to the area enclosed by the excitation coils 11. That is, the area of loops of the measurement coils 22 run parallel to the surface of the cylinder 12 over which the coil loops of the excitation coils run. Further, a measurement circuit 22 is coupled to the measurement coils to receive the voltage signals that are induced in the measurement coils due to eddy currents in an object in the examination volume 3. The measurement circuit is controlled by the system computer 30. For example, the measurements are taken sequentially or simultaneously from the respective sets of measurement coils at the same longitudinal position around the cylinder wall with the excitation of Helmholtz pairs near that longitudinal position. Alternatively, several Helmholtz pairs of excitation coils can be activated by the excitation circuit 13 in parallel and measurements are made from several measurement coils in parallel. The measurement circuit includes one ore more ultra low noise amplifiers. Such amplifiers have ultra low noise less than

1 nV/sqrt(Hz), fixed at a gain of 20 dB or more and thus due to voltage supply limits have a limited input voltage range. The output signals of the measurement circuit are applied to a reconstructor 4 which reconstructs image data form the output signals. The reconstructed images are displayed on a display 31. The reconstructor may be incorporated e.g. in software in the system computer 30.

The measurement circuit may also receive reference signals from magnetic field sensors, such as reference coils that are close to the excitation coils measure the excited magnetic field. The one or more reference coils are parallel to the excitation coils. It is also possible to measure the current that is driven in the excitation coils for reference purposes. The measurement circuit supplies these reference signals to the electronic system that uses the reference data in connection with the measurement data to compute the phase information for the measured data.

The measurement coils can be also be aligned to the excitation magnetic field to compensate field inhomogeneities. This can be achieved by tilting the measurement coils so that the measured portion of the excitation magnetic field is as small as possible (no conductive object is located inside the VOI, no eddy currents are produced).

FIG. 2 shows a schematic representation of a Helmholtz configuration on two coils. The Helmholtz configuration produces a homogeneous excitation magnetic field in the region between coils of an individual Helmholtz pair. A Helmholtz pair has two identical round magnetic coils placed symmetrically one on each side of the examination volume along a common axis, and separated by a distance h equal to the radius R of the coil. In operation each coil carries an equal electrical current flowing in the same direction. Setting h=R, which is what defines a Helmholtz pair, minimizes the non-uniformity of the field (B) at the centre of the coils, in the sense of setting d²B/dx²=0 (where x is along the separation of the two coils), but leaves about 6% variation in field strength between the centre and the planes of the coils. A slightly larger value of h reduces the difference in field between the centre and the planes of the coils, at the expense of worsening the field's uniformity in the region near the centre, as measured by d²B/dx². The more excitation coils are operated in parallel in Helmholtz mode, (i.e. parallel electrical currents are carried by opposite coils that have a separation equal to the radius of the coils) the better the homogeneity of the excitation field.

1. A magnetic impedance tomography system comprising
an excitation system with several excitation coils to generate an excitation magnetic field to induce eddy currents in an examination volume,
a measurement system with several measurement coils to measure the fields generated by the induced eddy currents,
the measurement coils being arranged in a volumetric (3D) geometrical arrangement and
the individual measurement coils being orientated substantially transverse to the field line of the excitation magnetic field of the excitation coils and
a reconstructor to receive measurement data from the measurement system and reconstruct an image of an object in the volume of interest from the measurement data.

2. A magnetic impedance tomography system as claimed in claim 1, wherein
the excitation system includes a pair excitation coils configured in parallel, in particular being arranged in a Helmholtz configuration or arranged as a solenoid.

3. A magnetic impedance tomography system as claimed in claim 1, wherein the measurement coils are arranged in a hemispherical geometrical arrangement.

4. A magnetic impedance tomography system as claimed in claim 1, wherein two of the excitation coils at opposite ends of the examination volume are electrically connected.

5. A magnetic impedance tomography system as claimed in claim 1 in which the excitation coils are arranged at the surface of a cylinder and the measurement coils are arranged transverse to the longitudinal axis of the cylinder.

6. A magnetic impedance tomography system as claimed in claim 1, in which the excitation system is arranged to excite the excitation coils in pairs.

7. A magnetic impedance tomography system as claimed in claim 1, in which the individual measurement coils are orientated slightly tilted with respect to the axis of the Helmholtz configuration, so as to be transverse to the local magnetic field generated by the excitation coils.

8. A magnetic impedance tomography system as claimed in claim 1, in which the measurement coils are arranged on a non-metallic carrier.
